(19) United States
(12) Patent Application Publication
(10) Pub. No.: US 2011/0031186 A1
(43) Pub. Date: Feb. 10, 2011

(54) CALCIUM CARBONATE AND CALCIUM CARBONATE-CONTAINING MATERIALS FOR REMOVING BIOAGENTS FROM WATER

(75) Inventors: Song Jin, Fort Collins, CO (US); Paul Fallgren, Highlands Ranch, CO (US); Anhuai Lu, Beijing (CN)

Correspondence Address: DUANE MORRIS LLP - Philadelphia;IP DEPARTMENT, 30 SOUTH 17TH STREET, PHILADELPHIA, PA, 19103-4196, US

(73) Assignee: Alternative Energy and Environmental Solutions, LLC, Sheridan, WY (US)

(21) Appl. No.: 12/842,379

(22) Filed: Jul. 23, 2010

Related U.S. Application Data
(60) Provisional application No. 61/231,239, filed on Aug. 4, 2009.

(51) Int. Cl. C02F 1/28; B01D 27/02; B01D 24/36; B01D 24/00; B01D 53/02; C02F 1/58

(52) U.S. Cl. 210/691; 210/679; 210/690; 210/263; 210/282; 210/290; 96/108; 95/141

(57) ABSTRACT

Calcium carbonate (CaCO₃; calcite) and CaCO₃-containing materials are known to have high adsorption capacities for polar organic compounds. This invention includes the use of CaCO₃ and CaC O₃-containing materials (e.g., synthetic calcite, calcite coated sorbents) and their mixture with other materials (e.g., activated carbon, resins) for removing bioagents (viruses, bacteria, hormones, pharmaceutical intermediates, and other hazardous biological agents) from waters.

### CROSS-REFERENCE TO RELATED APPLICATIONS

This is a non-provisional of pending U.S. provisional application Ser. No. 61/231,239, filed Aug. 4, 2009, the entirety of which provisional application is incorporated herein by reference.

### FIELD OF THE INVENTION

Aspects of the invention relate to water purity. Specifically, aspects of the invention relate to purifying water of contamination and pathogens in a cost effective manner.

### BACKGROUND INFORMATION

Pathogenic bio-agents, such as bacteria and viruses, exist ubiquitously in water systems. Numerous species of bio-agents are entering drinking water sources via pathways like sewage effluent, sludge, and solid wastes, septic tanks effluents, urban runoff, as well as agricultural practices. The use of untreated or inadequately treated water attributes to many water borne diseases, such as gastroenteritis, cholera, hepatitis, typhoid fever, and giardiasis. The main causative agents are bacterial and viral pathogens and protozoan parasites.

The most common pathogens are bacteria. They are usually within the range of 1000˜10000 nanometers (nm) in size and well adapted to aqueous environments. There are many types of pathogenic bacteria in polluted water systems. They are represented by the species such as Salmonella, Shigella, Vibrio cholerae, and Escherichia coli.

Viruses are also pathogenic agents that have been detected in all environments including water systems (Gerba and Rose, 1990). In municipal sewage, for example, more than 100 different viruses may be identified. Viruses, such as poliovirus, hepatitis A, echo, coxsackie, rota, adeno and Norwalk-like viruses are virulently hazardous at very low concentrations. Most viruses are small (20 to 200 nm) and consisted of nucleic acid encapsulated in a protein molecules. Viruses do not replicate like bacteria in the environment without their hosts.

Endocrine disrupting compounds (EDCs) are another group of “bioagents” that expose threat to the water systems. EDCs are natural or synthetic compounds (e.g., synthetic hormones, herbicides, pesticides, pharmaceuticals, and personal care products) that can adversely affect the endocrine system of living organism. Many of these compounds have been recently detected in wastewater effluents, agricultural runoff, and potable water supplies. Common EDCs found in the waterways are the biogenic hormone, for example 17β-estradiol (E2; CASRN 50-28-2; FW 272.3864), 17α-ethynylestradiol (EE2; CASRN 57-63-6; FW 296.4084), which have both been identified downstream from publically owned treatment works (POTW) in concentrations as high as 200 and 831 ng/L, respectively. Very low concentrations (ng/L range) of E2 and/or EE2 have been shown to affect the reproductive physiology and/or behavior of fish. Although the toxicological effects associated with chronic exposure to these compounds are unclear, the level of awareness and concern by medical professionals, government agencies, municipalities and the general public is increasing.

Numerous studies have attempted to quantify the ability of conventional and advanced treatment processes for removing EDCs from wastewaters. In general, EDC removal is highly variable and a function of the processes used, operating conditions, and the characteristics of the EDCs. Nanofiltration (NF) and reverse osmosis (RO) are two membrane processes that have shown some promise in effectively removing many different types of EDCs from various source waters. The efficiency of membrane processes to remove these compounds is limited as a result of the ability of some EDCs to adsorb to, and subsequently diffuse through, dense polymeric materials like NFIRO membranes. Furthermore, other low molecular weight organic compounds that are present in secondary effluent compete with the EDCs for adsorption sites on membrane surfaces, thus resulting in lower removals where adsorption is the primary removal mechanism. Membrane processes are also plagued by issues such as membrane fouling, relatively high pressure/energy requirements, and the production of residual concentrate streams that must be disposed of Activated carbon processes have also been found to be highly effective at removing a range of EDCs; however, EDCs that are more hydrophilic (the majority of EDCs) breach activated carbon faster than their more hydrophobic counterparts. Oxidation processes (ozone, UV-irradiation, hydrogen peroxide) are perhaps the least selective process for removing EDCs; however, these processes are energy intensive, expensive, complex and non-selective.

The occurrence of pathogenic bio-agents, including bacteria, viruses, and EDCs in water systems constitutes a serious threat to human health. The U.S. Environmental Protection Agency is proposing a series of new regulations to reduce the public health risk resulting from pathogenic contamination. Regulations on EDCs are expected to be promulgated in the near future, and the public concerns on EDCs have been increasing significantly. It is highly demanded that an effective technique to be developed to remove bio-agents from water systems. Ultraviolet irradiation, chlorination, and ozonation are commonly used disinfection methods in water treatment. These technologies are applicable only in large scale water treatment plants. They kill a majority of bio-agents yet low concentrations of pathogenic bio-agents may survive in the water. These existing technologies are not effective to EDCs due to their extremely low concentrations and unique compound structures. Secondary treatment at the user's end and water disinfection in the field become critical in complete removal of the water bioagents before it is safe to consume.

Therefore, new technologies are needed that are inexpensive to operate, able to remove a wide range of compounds, and capable of being integrated into existing treatment schemes.

Sorbing techniques have been commercialized for years in household and end user water treatment. Sorbent materials under current use include activated carbon, ionic exchange resins and synthetic fabrics. The loading capacity of these materials is usually low and frequent filter changes and material regeneration are necessary. Most of these sorbents possess negatively charged surface. Though some bio-agents are nonspecifically attached to the conventional sorbents, the low binding efficiency exclude the use of these sorbents as bio-agent remover. As previously stated, RO method uses nano-membrane as the filter, and is a highly effective tool to eliminate all impurities form water; however, the cost of this technology is well beyond the affordability of household and portable uses.

In addition, the energy and pressurizing requirements of a RO system limit its use in the needed cases like military or mobile applications.

The increasing concerns over biological contamination of drinking water, especially the worries about bio-terrorism and emerging contaminants such as EDCs, warrant the imminent development of a cost-effective technique that can be easily, applied to remove bio-agents from water systems. This invention applies calcium carbonate and calcium carbonate-containing materials as low cost, high efficient sorbents to remove bio-agents from waters.

Calcium carbonate (CaCO₃) is often in the form of the mineral calcite. Other mineral forms of CaCO₃ include for example aragonite and vaterite, but are less stable than calcite. Calcite occurs naturally and can be mined. It can be produced synthetically by bubbling CO₂ in a solution containing Ca(OH)₂ , CaCO₃ in the form of calcite is a common constituent of sedimentary rocks (e.g., limestone), volcanic rocks (e.g., carbonatites), metamorphic marble, and shells of marine organisms, such as plankton, sponges, brachiopoda, echinoferms, bryozoa, oysters, and rudists . CaCO₃ in the form of calcite has a trigonal-rhombohedral structure and exhibits several twinning types. A variety of calcite forms include fibrous, granular, lamellar, and compact. Calcite can have BET surface area up to 10 m²/g indicating high availability of sorption sites. Calcite is typically insoluble in water and becomes less soluble with increasing temperature. These properties make CaCO₃ and CaCO₃-containing materials ideal for bed material in water filtration systems.

CaCO₃ in the form of calcite has been used in removing metals from aqueous systems where the primary adsorption mechanism was ion exchange with Ca²⁺(Hay et al., 2003). However, adsorption of organic compounds onto calcite follows different mechanisms. Adsorption can occur when there is an electrostatic attraction between calcite and the organic compound, and a good fit for the organic compound in the lattice patterns (two-dimensional) on the calcite surface. The adsorption is enhanced by the insolubility of calcite and the availability of multiple adsorption sites due to high surface area of calcite.

Adsorption of organic compounds to calcite and other CaCO₃ containing materials, such as dolomite and magnesite, have been investigated. These organic compounds include fatty acids, amino acids, carboxylic acids, polar aromatic hydrocarbons, sulfonates, and carboxylated polymers (Suess, 1970; Carter, 1978; Zullig and Morse, 1988; Lagerge et al., 1993;Thomas et al., 1993a, 1993b; Madsen et al., 1996; Stefaniak et al., 2002; Suzuki, 2002; De Leeuw and Cooper, 2004; Duffy and Harding, 2004). Thomas et al. (1993a) observed that these organic compounds were strongly adsorbed to calcite, dolomite, and magnesite, in some cases, irreversibly adsorbed. To date, studies or inventions using calcite and other CaCO₃-containing materials in sorbing bioagents are not available.

### SUMMARY OF THE INVENTION

In this invention, the use of calcium carbonate and calcium carbonate-containing materials in bioagents removal from water systems are provided. Bioagents are broadly defined as pathogenic bacteria, viruses, EDCs, and other biological constituents that are currently list by USEPA with potential threat to human health and the environment.

A system for filtering fluid is disclosed. The system includes a carrier, and a quantity of calcium—carbonate (CaCO₃) associated with said carrier, wherein the carrier is configured to allow a user to contact the CaCO₃ with a fluid to remove a bioagent from said fluid.

A method is disclosed for filtering liquid. The method comprises: providing a quantity of calcium—carbonate (CaCO₃); and contacting said CaCO₃ with a fluid to remove a bioagent from said fluid.

A filter is also disclosed. The filter comprises a container having an interior volume, and a quantity of calcium-carbonate (CaCO₃) material disposed in the interior volume, wherein the container has an inlet and an outlet in fluid communication with said interior volume, said inlet, outlet and interior volume configured to enable a fluid to be introduced through the inlet to contact the CaCO₃ material.

### BRIEF DESCRIPTION OF THE DRAWINGS

FIG. 1 is an example embodiment of a mechanical or manual pump-action filtration of contaminated water for small-scale to scaled-up applications (e.g., portable water purifier for outdoor activities, well water treatment);

FIG. 2 is an example embodiment of a faucet filter attachment containing CaCO₃-containing materials mixed with activated carbon or resins;

FIG. 3 is a example embodiment of a water purification system (filter cartridge) using CaCO₃-containing materials to purify water;

FIG. 4 is a conceptual model of applying CaCO₃-containing materials in a granular multimedia filtration process in municipal water treatment;

FIG. 5 is a example embodiment of an arrangement applying CaCO₃-containing materials in a bag filtration or pressure-vessel process in municipal water or wastewater treatment;

FIG. 6 is an example embodiment of an arrangement applying CaCO₃-containing materials in a fluidized bed process in municipal water or wastewater treatment;

FIG. 7 is an example embodiment of an arrangement of bank filtration to protect surface water sources from run-off contamination; and

FIG. 8 is an arrangement of CaCO₃-containing materials in a fiber cartridge that can be dropped into water bottles or containers to removal bioagents.

### DETAILED DESCRIPTION

In aspects of the invention, it has been determined that protein polypeptides components in bacterial and virus surface structures and anionic features in most EDCs would enable them to be sorbed by calcite and other CaCO₃-containing materials, which demonstrate positive surface charges under ambient conditions.

In recent work by the inventors, crushed calcite was tested for removal of bacteria from river water. For example, suspension tests involved mixing 3 wt % crushed calcite in river water collected near the discharge point of a municipal wastewater treatment plant. The mixture was shaken for 5 min and the bacteria in the water were counted by microscopy.

The calcite decreased the bacteria concentration from 1.34×10⁸ to 7.79×10⁶ cells/mL (94.2% removal). A column test was conducted with 3 g calcite packed into a column and 1 L river water was filtered through the column. Complete removal of bacteria was observed through the fixed bed of calcite. The high affinity of bacteria for calcite surface indicates that CaCO₃-containing materials, natural and synthetic, can be applied in water treatment and other treatment systems where the removal of bacteria and other bio-agents (e.g., viruses, protozoa) is critical.

Mechanisms research and preliminary tests also demonstrate effective removal of EDCs from waters.

### EXAMPLE USES

1) Field filtration apparatuses:

CaCO₃ and CaCO₃-containing materials can be packed or coated to carrier materials to make water filtration units. The filtered water, under this design, will be drinkable. This type of apparatuses may be made as disposable tubes, pumps, columns, and other tools to produce drinkable water in the field where no potable water is available.

2) Household water filter:

CaCO₃ and CaCO₃-containing materials can be packed into a unit with activated carbon that connects to tap water faucet directly or through an adaptor. The filtered water will be free or very low in metals and potential pathogenic agents.

3) Large scale water treatment:

CaCO₃ and CaCO₃-containing materials may be used in a large-scale fixed- or fluidized bed filtration, which can be added to conventional drinking water or wastewater treatment process as a polishing step for disinfection.

4) Bioagent collector:

CaCO₃ and CaCO₃-containing materials can be coated to a carrier material and used to concentrate bio-agents, such as viruses, bacteria, EDCs and other biological molecules. The collected material-bioagents will serve as samples for detection, identification, characterization and other applications. The CaCO₃ containing collector will highly concentrate bioagents present in water bodies; therefore it may increase the sensitivity of early detection of bioagents in waters.

5) Air filtration and purification:

Based on the same adsorption mechanisms, CaCO₃ and CaCO₃-containing materials can be coated on a carrier material, or directly used and configured into a cartridge or filling material, and used as air filters that possess high affinity to potential pathogens in the air. The filters can be used for both residential and commercial buildings, airplanes, trains, automobiles, and health care devices such as face masks.

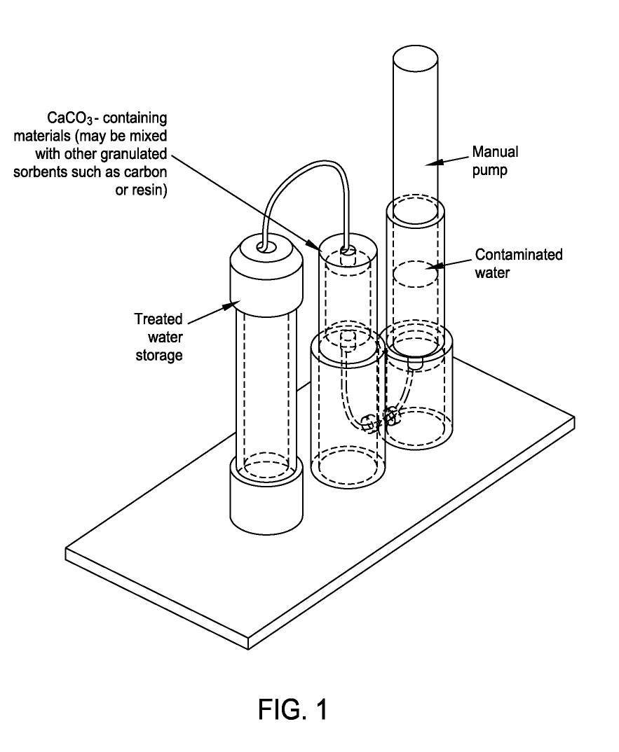

FIGS. 1-8 demonstrate example designs and applications of CaCO₃ and CaCO₃-containing materials.

FIG. 1 illustrates a design for mechanical or manual pump-action filtration of contaminated water for small-scale to scaled-up applications (e.g., portable water purifier for outdoor activities, well water treatment). A flow-based indicator may be added to the device to signal when the filter material should be exchanged.

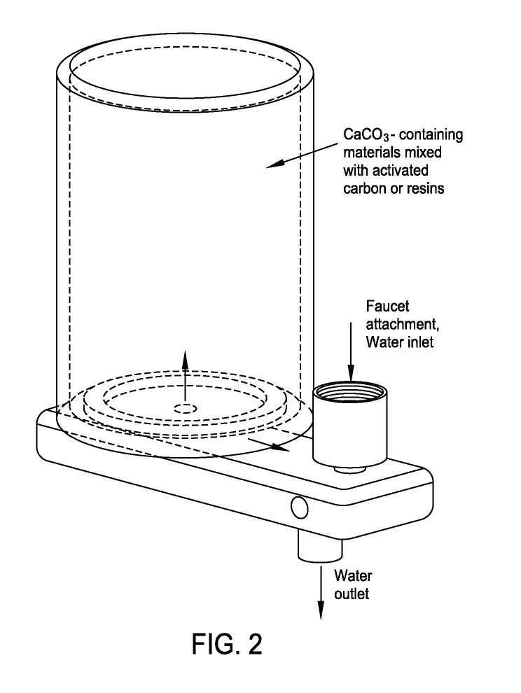

FIG. 2 illustrates a faucet filter attachment containing CaCO₃-containing materials mixed with activated carbon or resins. These materials may be mixed or placed in separate layers. A flow-based indicator may be added to the device to signal when the filter material should be exchanged.

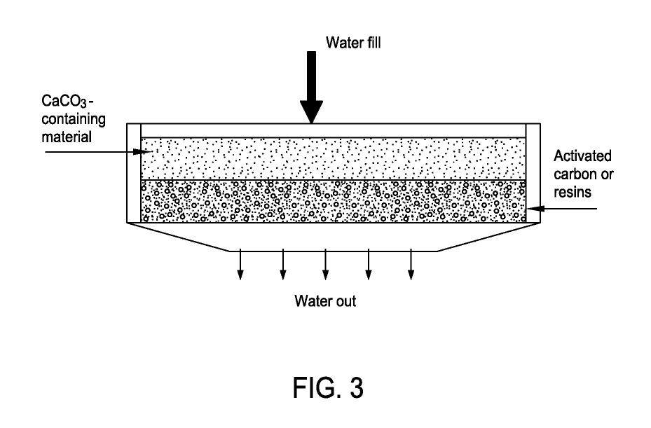

FIG. 3 illustrates a design of a water purification system (filter cartridge) using CaCO₃-containing materials to purify water for drinking One example use would be for a water pitcher. This design can be extended and modified into drinking bottles and other containers with a filter cartridge. Based on a conservative estimate of water quality and consumption, filter materials will be changed at frequencies on a sliding scale. This design can also be used as a cartridge for air filtration, for example in masks, airplanes, building and other situations involving air venting.

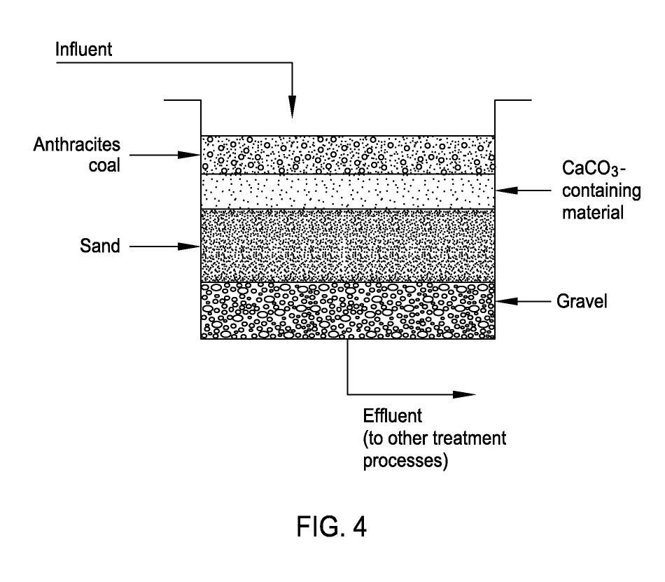

FIG. 4 illustrates a design for applying CaCO₃-containing materials in a granular multimedia filtration process in municipal water treatment. This process will typically occur after the sedimentation,. Flocculation, or coagulation steps in water treatment depending on the overall water treatment design (e.g., post-sedimentation for conventional water treatment design).

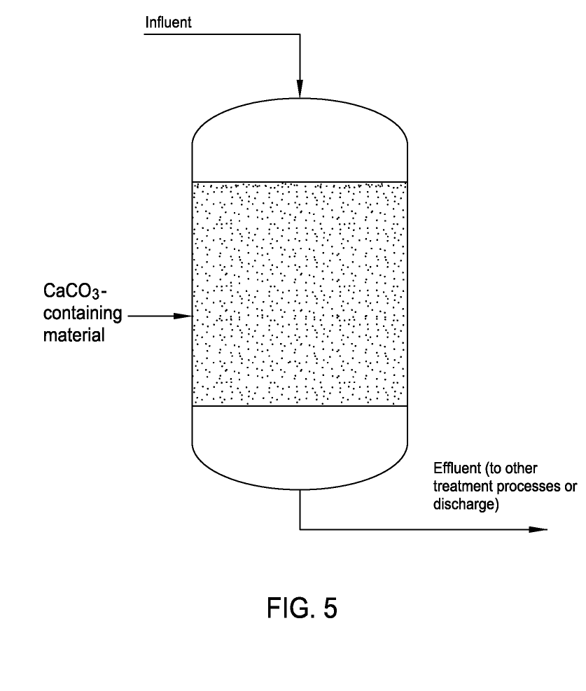

FIG. 5 illustrates a design for applying CaCO₃-containing materials in a bag filtration or pressure-vessel process in municipal water or wastewater treatment. This process would be applied after the conventional granular filtration step or before membrane processing in water treatment depending on the overall water treatment design. It would also be used to treat the effluent water of wastewater treatment before discharge.

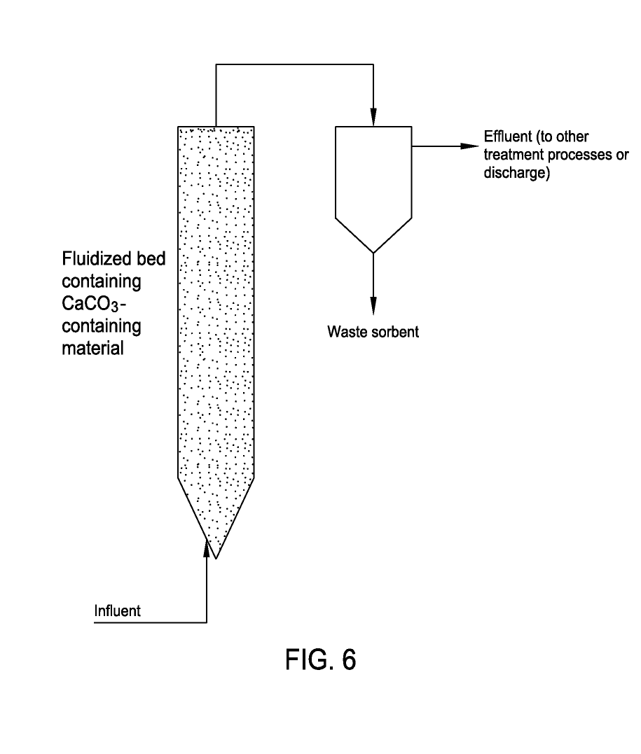

FIG. 6 illustrates a design for applying CaCO₃-containing materials in a fluidized-bed process in municipal water or wastewater treatment. This process would be applied after the conventional granular filtration step or before membrane process in water treatment depending on the overall water treatment design. It would also be used to treat the effluent water of wastewater treatment before discharge.

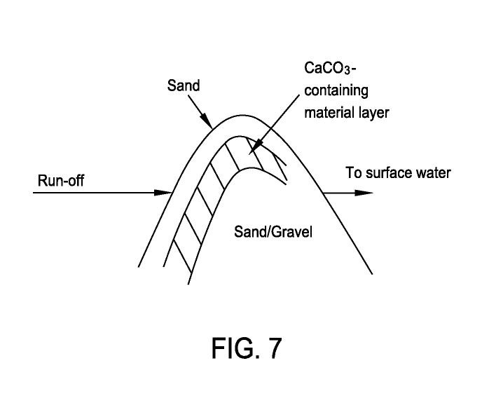

FIG. 7 illustrates a design for bank filtration to protect surface water sources from run-off contamination. A scaled down design can also be used as a boom filter for similar applications. One exemplary use is in agricultural areas, for protecting from pathogens from animal manure.

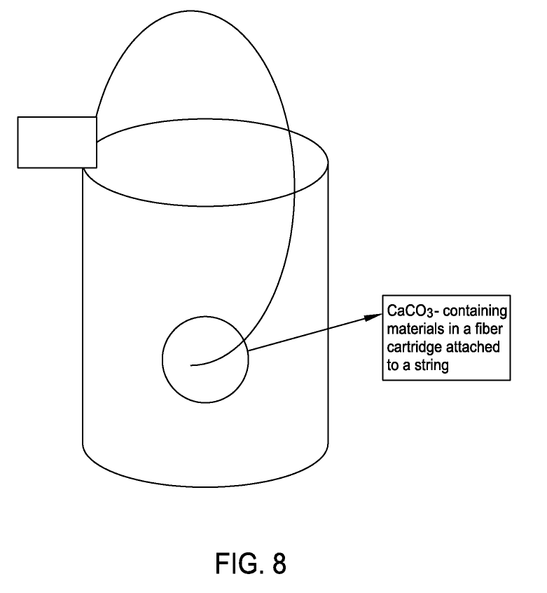

FIG. 8 illustrates CaCO₃-containing materials in a fiber cartridge that can be dropped into water bottles or containers to remove bioagents. The cartridge can be conveniently removed and disposed of after a certain period of time.

It will be appreciated that although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A system for filtering fluid, comprising:
a carrier, and
a quantity of calcium-carbonate (CaCO₃) associated with said carrier;
wherein the carrier is configured to allow a user to contact the CaCO₃ with a fluid to remove a bioagent from said fluid.

2. The system of claim 1, wherein said CaCO₃ is coated on the carrier.

3. The system of claim 1, wherein said CaCO₃ is provided in an interior volume formed in said carrier.

4. The system of claim 1, wherein said liquid is water, and said bioagent is selected from the list consisting of a virus, a bacteria, and an endocrine disrupting compound.

5. The system of claim 1, wherein said fluid is selected from the list consisting of a liquid and a gas.

6. The system of claim 1, wherein said carrier comprises a filter cartridge.

7. The system of claim 1, wherein said carrier comprises a fluidized bed.

8. The system of claim 1, wherein said carrier comprises a sand bank.

9. A method for filtering liquid, comprising:
providing a quantity of calcium-carbonate (CaCO₃); and
contacting said CaCO₃ with a fluid to remove a bioagent from said fluid.

10. The method of claim 9, wherein said step of providing a quantity of CaCO₃ comprises disposing said CaCO₃ in a filter cartridge.

11. The method of claim 9, wherein said step of providing a quantity of CaCO₃ comprises providing a CaCO₃ layer within a bank comprising sand or gravel.

12. The method of claim 9, wherein said step of contacting said CaCO₃ with a fluid comprises contacting the CaCO₃ with air or water.

13. The method of claim 9, wherein said bioagent is selected from the list consisting of virus, a bacteria, and an endocrine disrupting compound.

14. The method of claim 9, further comprising the steps of:
passing the fluid through a layer of anthracite coal prior to contacting said CaCO₃ with said fluid,
passing the fluid through a layer of sand after contacting said CaCO₃ with said fluid; and
passing the fluid through a layer of gravel after passing the fluid through the layer of sand.

15. The method of claim 9, further comprising coating a carrier with said CaCO₃ and collecting a concentration of said bioagent on said carrier for use as a sample for detection, identification, or characterization of said bioagent.

16. A filter, comprising:
a container having an interior volume, and
a quantity of calcium-carbonate (CaCO₃) material disposed in the interior volume,
wherein the container has an inlet and an outlet in fluid communication with said interior volume, said inlet, outlet and interior volume configured to enable a fluid to be introduced through the inlet to contact the CaCO₃ material.

17. The filter of claim 16, wherein said container comprises a filter cartridge.

18. The filter of claim 16, wherein said container comprises a fluidized bed.

19. The filter of claim 16, wherein said interior volume further contains a quantity of a material selected from the list consisting of activated carbon, resin, sand and gravel.

20. The filter of claim 16, wherein the container comprises a pressure vessel.
